(19) United States
(12) Patent Application Publication
(10) Pub. No.: US 2007/0064898 A1
(43) Pub. Date: Mar. 22, 2007

(54) TELEPHONE CONFERENCE SYSTEM

(76) Inventors: Kiyoshi Amano, Tokyo (JP); Takayuki Morimura, Tokyo (JP)

Correspondence Address: LEIGHTON K. CHONG;GODBEY GRIFFITHS REISS & CHONG, 1001 BISHOP STREET, PAUAHI TOWER SUITE 2300, HONOLULU, HI, 96813, US

(21) Appl. No.: 11/461,976

(22) Filed: Aug. 2, 2006

Related U.S. Application Data
(63) Continuation-in-part of application No. 10/379,883, filed on Mar. 4, 2003, now abandoned.

(51) Int. Cl. H04M 9/00; H04M 1/60

(52) U.S. Cl. 379/168

(57) ABSTRACT

A telephone conference system has a voice response board 6 for connecting a plurality of phone lines in a telephone conference, a voice synthesis board 8 for synthesizing voice signals for participants of a telephone conference in a designated one of a plurality of conference rooms, and a control section 18 for checking the status of a telephone conference and controlling connection of the phone lines for the conference. A host can input the phone numbers of intended participants of a telephone conference, and the system automatically calls the phone numbers of the intended participants and plays a recorded message to join the telephone conference within a scheduled time. When the participants call in to connect with the telephone conference, the caller ID numbers of their phone lines are compared to the recorded phone numbers to determine if they are true participants of the telephone conference.

This U.S. patent application is a continuation-in-part of U.S. patent application Ser. No. 10/379,883 filed on Mar. 4, 2003, of the same title, and by the same inventor.

### BACKGROUND OF THE INVENTION

This invention relates to a telephone conference system in which a telephone conference with multiple parties is held on a phone such as a cell phone, a PHS phone (Personal Handyphone System), a landline phone or the like.

Conventionally, a telephone conference can be held using a videoconference phone which displays an image of the called party to the calling party and vice versa along with audio sound of the parties' voices. This requires each side to have a microphone, a video camera for transmitting an image of the person speaking, and a display screen for displaying the received image of the other person, in addition to the usual telephone equipment.

As another type of phone conference system in which images of the speakers are not exchanged, there is a so-called INS (Information Network System) phone conference service, such as provided by NTT EAST (Nippon Telegraph and Telephone Corporation EAST) in Japan. The service is one in which a calling party registers the date and hour of the intended phone conference and the intended participants prior to the phone conference. The calling party and other participants are then called from a telephone connecting service on the designated day and hour. The system has advantages in that the phone conference can be held on time and up to 30 phones can be simultaneously connected. However, all parties to the connecting service must be connected around the same time through an operator at a telephone conferencing center, and is therefore limited in general to daytime hours. Furthermore, the calling party has to assume that the participant at the called number is the true participant authorized to participate in the conference. As a result, the calling party cannot check whether the actual person participating is authorized to listens to the content of the conference.

Furthermore, although present PBX (private branch exchange) systems are digital in structure, the common PBX system uses IC (integrated circuits) without a memory function for multi-party connection through the PBX system. Even if a connection is made, the PBX only has functions for connecting extension telephones within the exchange system and connecting to the outside party. Therefore, an external connection and disconnection cannot be made in accordance with the phone number of the external party.

Recently, a CTI (computer telephonic) system has become widely used, and utilizes a personal computer for the function of connection of telephone lines. CTI systems aim to combine a voice network of a telephone network with a data network of a LAN (local area network). Specifically, a personal computer is equipped with a telephonic board for use as a phone and a private branch exchange. The PBX (private branch exchange) of the computer is called UnPBX and plays the role of the telephonic exchange. The UnPBX is equipped with a voice signal processing board and is a server configured to operate as a simple PBX, and also has a function to store data by using a hard disc.

### SUMMARY OF THE INVENTION

It is therefore an object of the present invention to provide a telephone conference system that requires no additional labor and cost to operate the system, functions like a UnPBX system so that an operator is not needed, and allows a plurality of persons to be connected on their phones simultaneously.

It is another object of the present invention to provide a telephone conference system in which a person who is not authorized to participate is recognized as an unauthorized party if it does not call in with a correct ID (identification) provided by the calling party on a UnPBX-like system. A further object is that multiple external participants can be connected and participate in a telephone conference simultaneously.

To accomplish the object of the present invention there is provided a telephone conference system for connecting a plurality of phone lines of participants in a telephone conference comprising:

a voice response board for receiving and transmitting push tone signals and voice signals from and to each phone line of a participant, and for recording and reproducing the voice signals for a telephone conference in response to participant input indicated by the push tone signals;

a voice synthesis board coupled to the voice response section capable of establishing a plurality of telephone conference “rooms” in which voice signals from each participant's phone received for a specific conference room by said voice response board are synthesized as voice sounds for the other participants in the conference room; and

a control section for checking the available status of a conference room of said voice synthesis board, and for receiving line information of each phone line from and transmitting requests for connection with other phone lines to said voice response section in response to an indicated available status of the conference room of said voice synthesis board,

wherein said control section designates a conference room to be connected to each phone line of the participants in a telephone conference connected to said voice response board, the voice signals of the plurality of phone lines of participants are synthesized and are connected by exchange in said designated conference room, and a plurality of persons are thereby enabled to participate in a telephone conference simultaneously through their respective phones.

There is also provided a telephone conference system for connecting a plurality of phone lines of participants in a telephone conference using a computer system comprising:

a voice response board for receiving and transmitting push tone signals and voice signals from and to each phone line of a participant, for recording and reproducing the voice signals for a telephone conference in response to participant input indicated by the push tone signals, and for recording the phone numbers of intended participants and recognizing caller ID (identification) numbers of calling parties re-connecting for a telephone conference for comparison to the recorded phone numbers of intended participants to the telephone conference stored by said voice response board;

a voice synthesis board coupled to the voice response section and provided with a plurality of conference rooms, wherein voice signals from each participant's phone received for a specific conference room by said voice response board are synthesized as voice sounds for the other participants in the conference room, and for connecting by exchange the phone lines re-connecting with said voice response board in accordance with recognizing the caller ID numbers of the phone lines matching the phone numbers stored by said voice response board; and

a control section for checking the available status of a conference room of said voice synthesis board, and for receiving line information of each phone line from and transmitting requests for connection with other phone lines to said voice response board in response to an indicated available status of the conference room of said voice synthesis board,

whereby the telephone conference system through said voice response board is enabled to recognize the caller ID numbers of phone lines to be connected to a conference room and compare them to the recorded phone numbers of the intended participants to the telephone conference to determine if they are true participants to the telephone conference.

Other objects and aspects of the invention will become apparent from the following description of the preferred embodiments, with reference to the accompanying drawings in which:

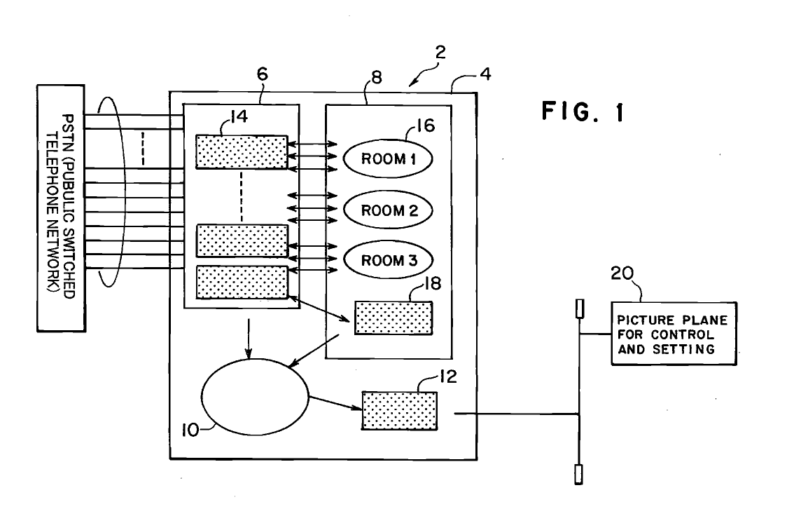

FIG. 1 is a block diagram showing a functional configuration of a telephone conference system common to first and second embodiments according to the present invention,

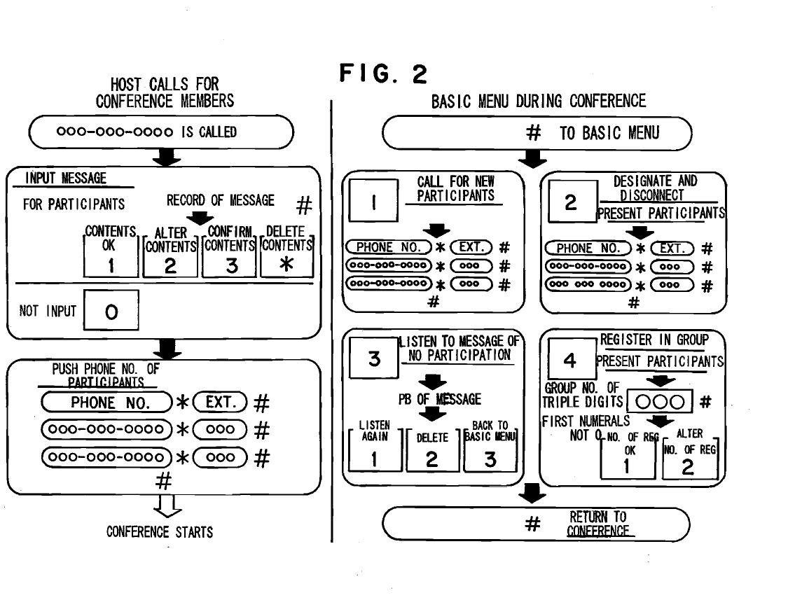

FIG. 2 is a process diagram in which featured functions of the telephone conference system are illustrated,

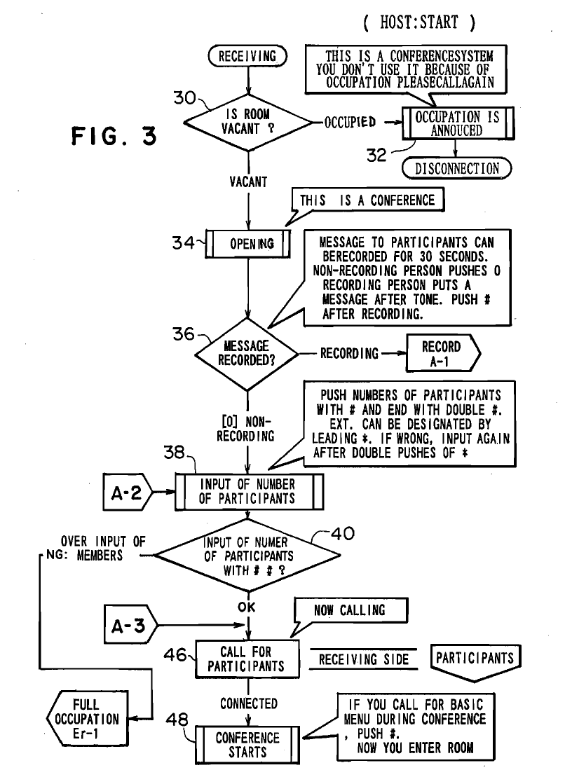

FIG. 3 is a flowchart showing a start menu for a telephone conference organizer illustrating the processing operation of a telephone conference system,

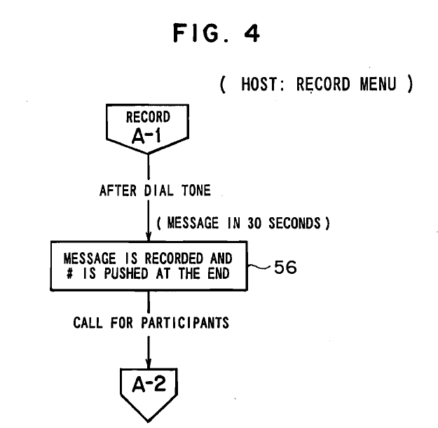

FIG. 4 is a flowchart showing a record menu for a telephone conference organizer illustrating the processing operation of the telephone conference system,

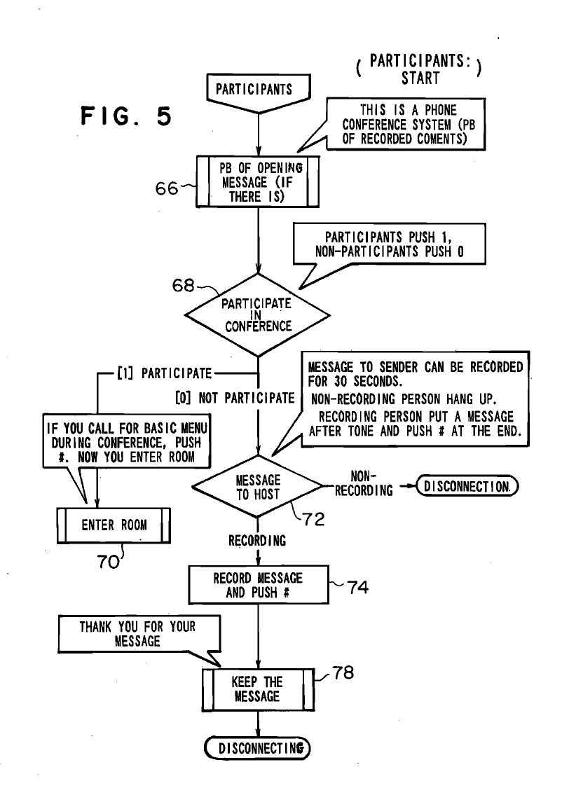

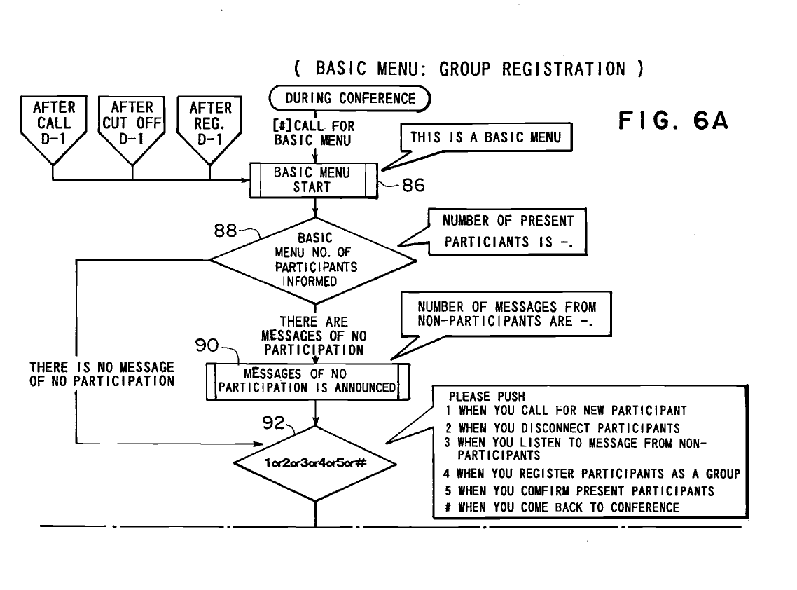

FIG. 5 is a flowchart showing a start menu of a participant in the processing operation of the telephone conference system,

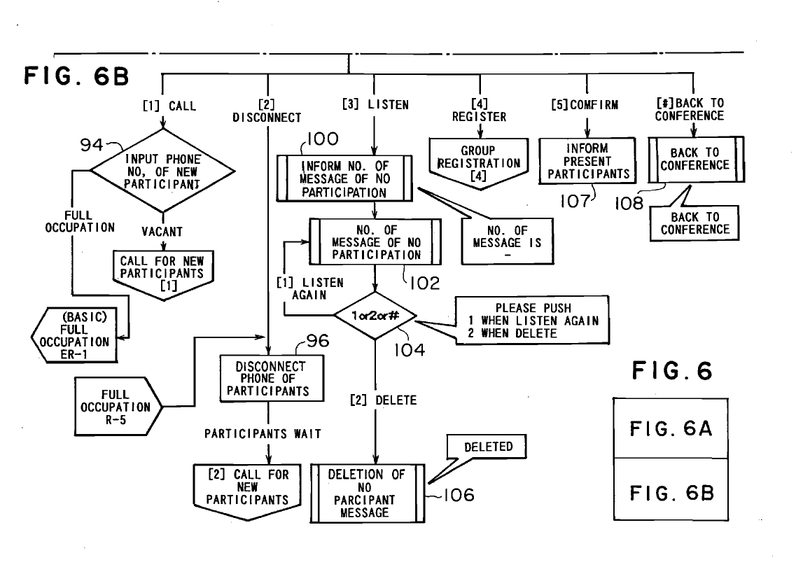

FIGS. 6A and 6B are connecting flowcharts showing a basic menu in the processing operation of the telephone conference system,

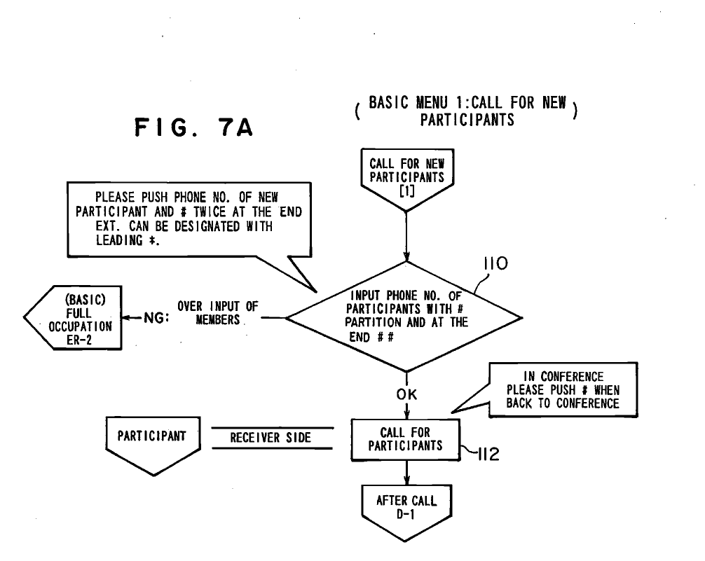

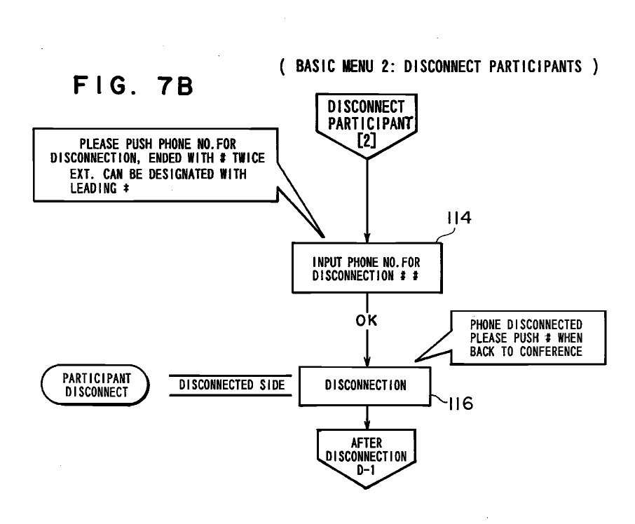

FIG. 7A is a flowchart of “Mode of call for new participant” and FIG. 7B is a flowchart of “Mode of removal of participant”,

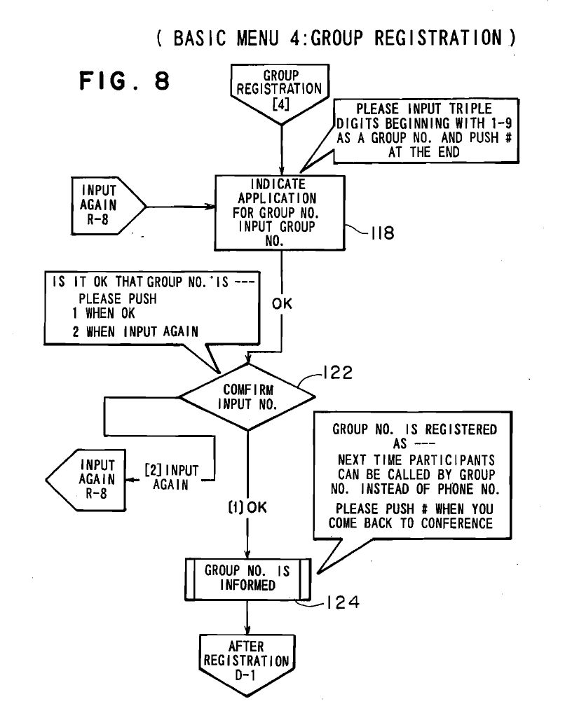

FIG. 8 is a flowchart showing a menu for group registration in the processing operation of the telephone conference system,

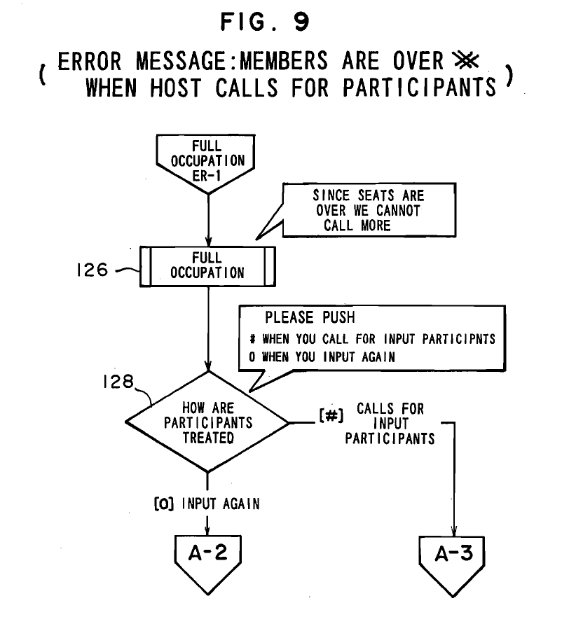

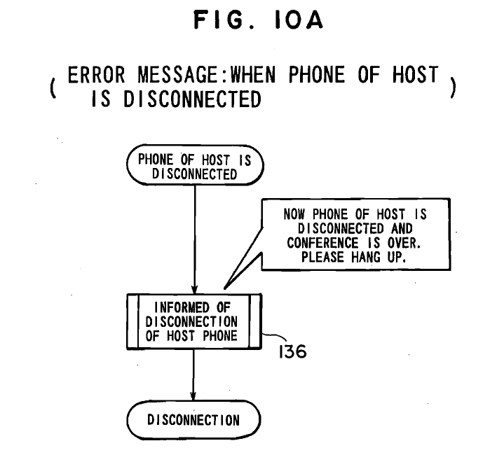

FIG. 9 is a flowchart showing an error message provided in a case where the number of participants goes over the number specified by the organizer for the participants,

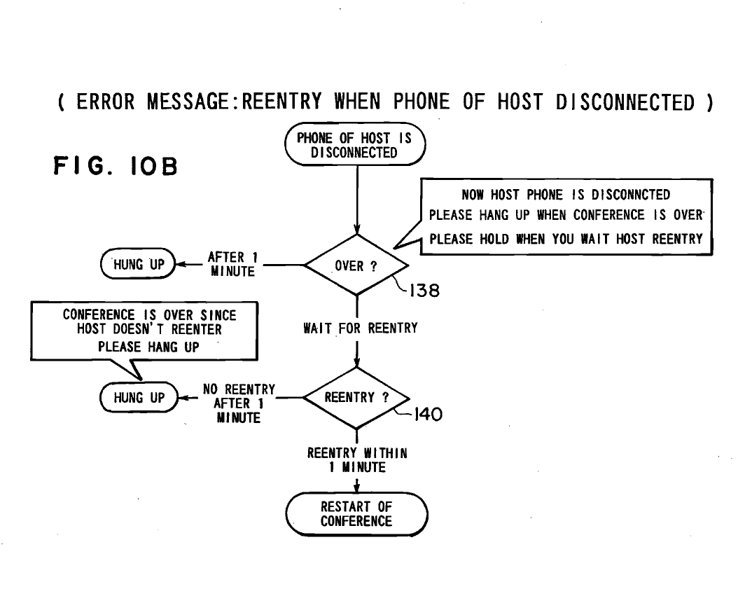

FIG. 10A is a flowchart showing an error message in a case where the telephone of the organizer is disconnected, shut off or put down, and FIG. 10B is a flowchart of an error massage for reentry to a conference room when the telephone of the organizer is shut off,

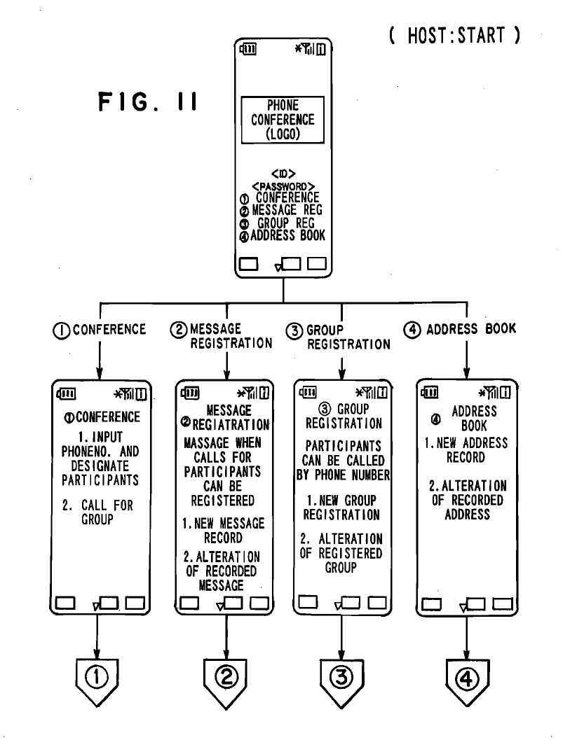

FIG. 11 is a view of a display of the input interface for an “Organizer start” menu of a portable telephone or cell phone,

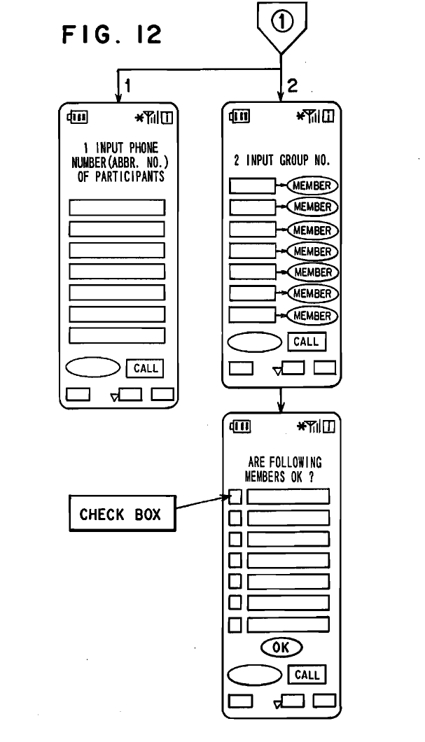

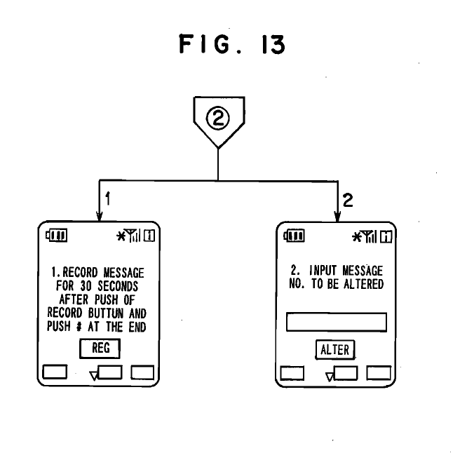

FIG. 12 is a view showing a display of the input interface of a portable phone after Option “1” (Conference) is selected in FIG. 11,

FIG. 13 is a view showing a display of the input interface of a portable phone after Option “2” (Message Registration) is selected in FIG. 11,

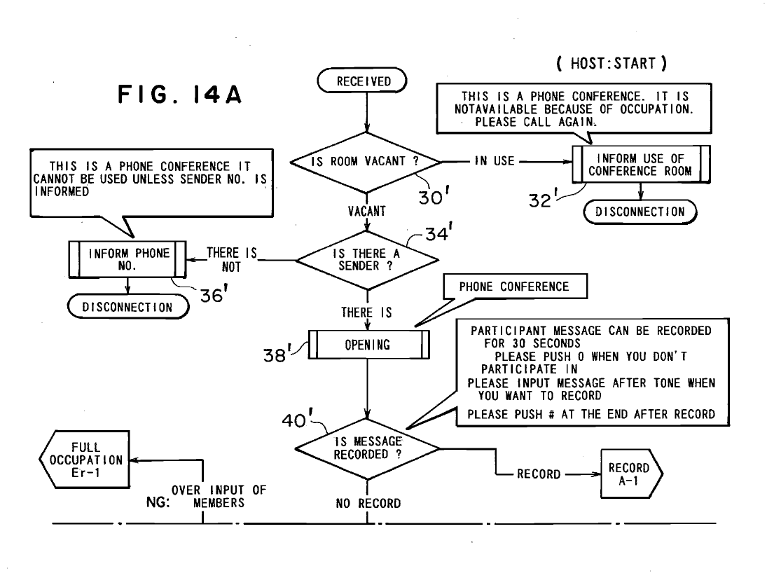

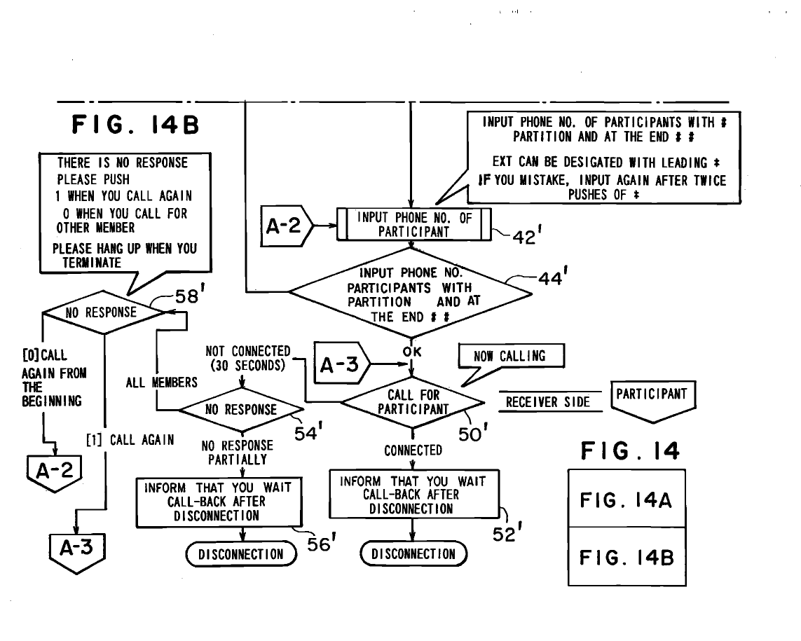

FIGS. 14A and 14B are connecting flowcharts showing a start menu of a telephone conference organizer in the processing operation of the telephone conference system,

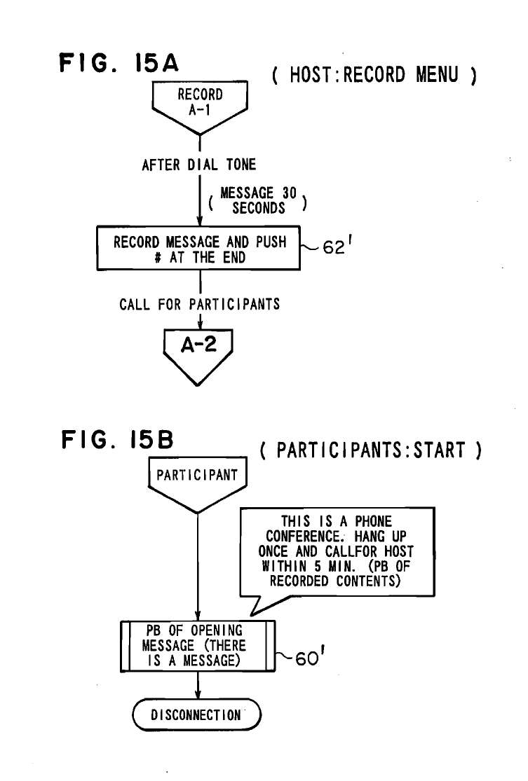

FIG. 15A is a flowchart showing a record menu of a host, and FIG. 15B is a flowchart showing a start menu of a participant,

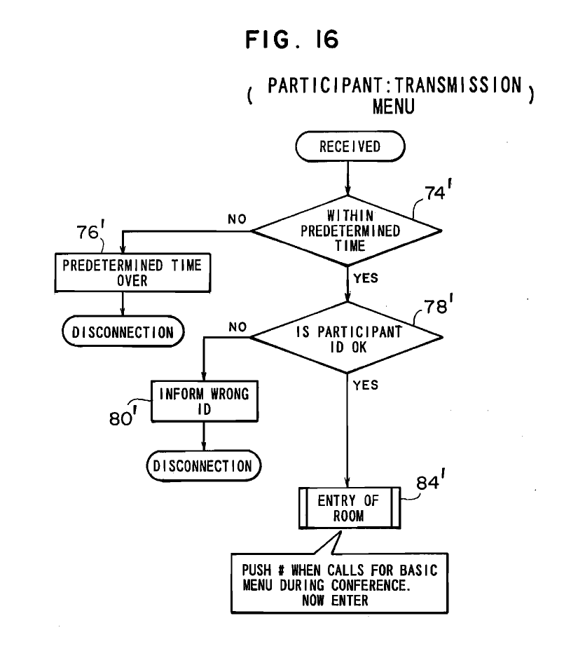

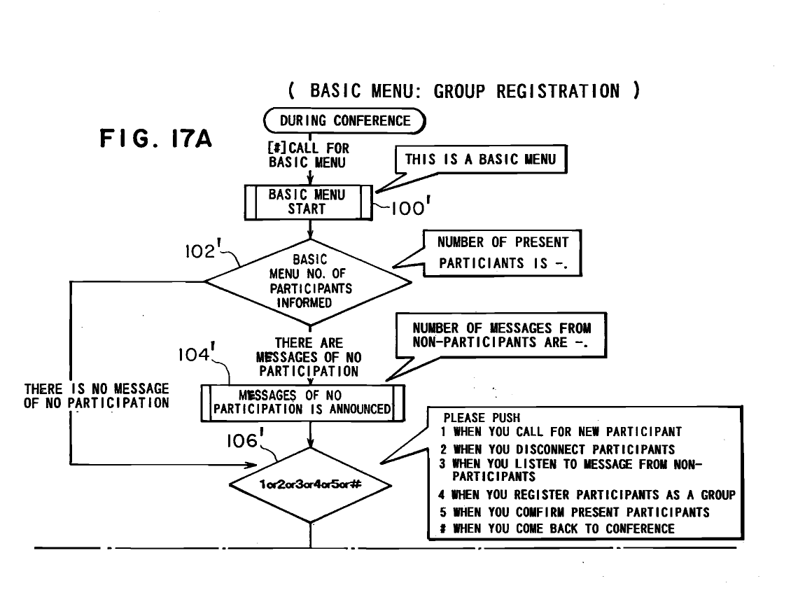

FIG. 16 is a flowchart showing an outgoing mail or transmission menu of a participant in the processing operation of the telephone conference system,

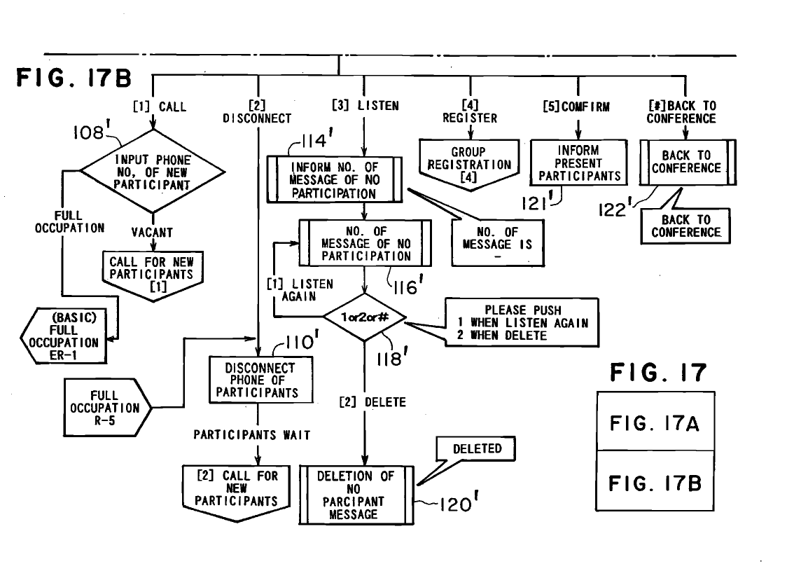

FIGS. 17A and 17B are connecting flowcharts showing a basic menu in the processing operation of the telephone conference system,

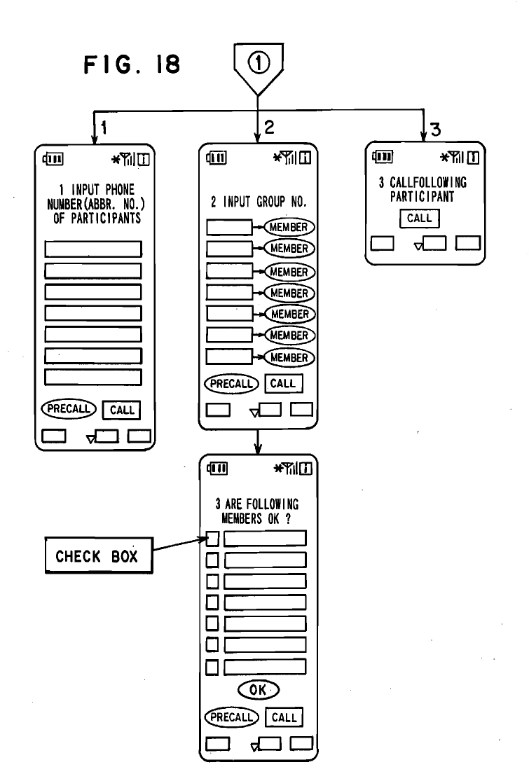

FIG. 18 is a view showing a display of the input interface of a portable phone after Option “3” (Group Registration) is selected in FIG. 11.

### DESCRIPTION OF THE PREFERRED EMBODIMENTS

### First Embodiment

In a first embodiment, a telephone conference system is described in a case where a portable phone, a PHS (Personal Handyphone System) phone, a general landline telephone, or the like (hereinafter referred to as “phone” or “telephone”) is connected to the telephone conference system and a telephone conference is carried out.

FIG. 1 is a block diagram showing a functional configuration of the telephone conference system common to the first and second embodiments described herein according to the present invention. In FIG. 1, a telephone conference server 4 is connected through a public switched telephone network (PSTN), such as NTT (Nippon Telegraph and Telephone Corporation) or TTNet (Tokyo Telecommunication Network Co., Inc.), Japan, to the telephones of users through their phone lines.

The server 4 comprises a voice response board 6, a voice synthesis board 8, a record section 10, and a display operating section 12. A display 20 having a picture plane displaying images and providing a visual interface for the system user is connected to the server 4 through a connection such as a LAN (local area network).

The voice response board 6 is connected to the telephone of the user through a phone line and has a receiver and transmission function to receive phone communication or push tone signals from the user and to transmit phone communication or push tone signals to the user. Furthermore the voice response board 6 has a voice guide function to record or play back voice responses in response to push tone signals or line signals received or transmitted from or to the user.

The voice response board 6 has a plurality of sections for accommodating simplified user instruction modules 14. Each simplified user instruction module 14 activates an associated voice/FAX board to provide a simple instruction to the user. The user instruction module 14 also has a function of receiving and transmitting push tone signals and a function of record and play back of voice signals, and thus makes use of the functions of the voice response board 6 easy to navigate.

The simplified user instruction module 14 also can have a function for activating an outside program and to receive its executed effects. It can be combined with a database or various applications freely to construct a large-scale telephone conferencing program, thus enhancing the productivity of this configuration of the voice response system.

The voice synthesis board 8 is connected to the voice response board 6 and has a plurality of telephone conference “rooms” 16. Each room 16 is a section in which signals transmitted from the voice response board 16 is connected to a designated phone or disconnected from a designated phone by exchange function. Each room 16 has a function in which a plurality of member phones can be simultaneously connected to each other in response to a line signal transmitted from a host phone by exchange function. Furthermore, each room 16 can receive push tone signals from a host or a member phone during an exchange, and can be connected to a newly designated phone by exchange in response to push tone signals thus received. When transmitted to the newly designated phone, although the voice response board 6 acts for transmission, a line other than the line now used is used for transmission. Each room 16 can differ in the number of phones in exchange use in a conference, and the maximum number of phones can be predetermined for each room 16.

The voice synthesis board 8 has a control section 18. The control section 18 controls the status of each room 16 and at the same time has a function to receive signals from the simplified user instruction module 14 of the voice response board 6 in response to the control status of each room and to transmit indication signals to the simplified user instruction module 14. The status of each room 16 may consist of how many other phones a certain phone is now connected to, how many other phones a certain phone can be further connected to, or the like. Furthermore, when the push tone signals from the host phone reach the server 4 at first, a specific room in which a conference is carried out is acquired by the indication of the control section 18.

A record section 10 is connected to the voice response board 6 and the voice synthesis board 8 and mainly records log information. That is, the record section 10 receives the information from the simplified user instruction module 14 and the information from the control section 18 to accumulate information, for example, at what time a log-in is made, how many members are logged in, how long a phone conference is carried out in a room, and how many members remain in.

A display operating section 12 is connected to the record section 10 and activates a specific user instruction by software to display the information on the log of the record section 10. The log information is put out in HTML (Hyper Text Markup Language) format by activating a specific user instruction and running a specific application.

A display section 20 is connected to the server 4 through a LAN and receives the log information from the display operating section 12. The display section has a picture plane or screen for user interface, and the log information in HTML format is displayed on the picture plane such as with a browser like IE (Internet Explorer of Microsoft Corp.). The user interface sequences are carried out by the user while watching the picture plane. Any changes in the number of phones or the full number of members by which the exchange for connection can be made at once or concurrently and the setting for the period in which the exchange for connection can be made on the plurality of phones simultaneously are made through the picture plane. Since the log information can be seen on the picture plane of the display section 20 in real time, the present status of the server 4 can be promptly recognized by the user. Furthermore, the setting for the number of members and the setting for a conference period may be made by the users of the phone conference system.

Now, the operation of the above-mentioned construction will be explained. A phone is connected to the phone conference server 4 through the public network by transmitting push tone signals for its phone number. In the server 4, the simplified user instruction module 14 of the voice response board 6 receives the call signal from the push tone signals. Thereafter, the signal for requesting the status of each room 16 reaches the control section 18, and the control section 18 transmits signals indicating connection of the line signal to the simplified user instruction module 14 in response to the status of each room. The simplified user instruction module 14 transmits the line signal to the connected room 16 in accordance with the indicated signals, and then the line signal is connected by exchange in the indicated room. A confirmation signal is put out to the simplified user instruction module 14 and to the designated phone. The log information during the period is transferred from the simplified user instruction module 14 to the record section 10 through the control section 18 and also can be seen on the display section 20 operated through the display operating section 12 in real time.

On the basis of above-mentioned hardware configuration the typical conference call processing operations will be explained in more detail. FIG. 2 is a process diagram in which the featured functions of the telephone conference system are illustrated with reference to FIGS. 3-10, which are flowcharts showing in detail the processing operations of specific functions of the telephone conference system. In the flowcharts, a rectangular frame indicates a message given to the user in voice.

It is assumed that a person calling for a phone conference is a host and a person called in is a participant or member.

Referring to FIG. 2 in conjunction with FIG. 3, at the start of the start menu the host makes a phone call to the server 4 and sends push tones indicating a request for a conference room, and the server then checks whether a conference room 16 is vacant (step 30). In case the room is used, an in-use reply message (step 32) is sent to the host who then disconnects. If the room is vacant, an opening conference message is delivered (step 34) and whether a message to participants is to be recorded is requested (step 36). If desired the host can record a message to be delivered to the participants. For recording, the procedures go to the “Record A-1” mode. In case of non-recording, the host is prompted to input the phone numbers of the participants (step 38).

As the phone numbers of the participants are input, a check is made (step 40) whether the total number is over the limit for the conference room 16. If so, the procedures go to the “Full occupancy Er-1” menu. The host continues to input the phone numbers for the participants as long as they are not over the limit, and when all are in, the participants are called to join the conference room 16 (step 46). When the phones are connected the conference starts (step 48). The called participants now enter a start menu for the “Participant” mode.

In FIG. 4, the “Record menu” for a host is shown, which is the routine “Record A-1” from FIG. 3. After a tone is given, the host records the message for the participants (step 56). After recording the procedures go to the “A-2” mode to input the numbers for the participants. The “A-2” mode is linked to “step 38” in FIG. 3.

In FIG. 5, a participant “Start menu” is shown. When the participant gets a phone call for the conference initiated by the host, an opening message is announced. In case that there is a message recorded by the host, the recorded message is played back (step 66). The participant is asked whether he/she will attend the conference (step 68), and if a push tone indicating “yes” is received, the participant is connected to the conference room (step 70). In case the participant does not want to attend, an inquiry is made whether the participant wants to record a message to the host (step 72). In case of non-recording, the participant disconnects or hangs up the phone. In case of recording, the participant records the message (step 74). After recording, the message is stored (step 78), then the participant hangs up.

In FIGS. 6A and 6B, a basic menu for Group Registration is shown. When the basic menu is called during the conference, the basic menu start message is announced (step 86). The number of conference participants is announced (step 88). In case there are any non-attendance messages, the messages of non-attending participants are announced (step 90). A menu is then provided to choose whether a new participant is to be called, whether the phones of any present participants are to be disconnected, whether the participant want to listen to the non-attendant messages, whether a group registration is to be made, whether the present participants are confirmed, and whether the participant intends to return to the conference (step 92). In case there is no non-attendance message at step 88, the procedures go to the step 92.

In case that a new participant is to be called, the number of the new participant is input (step 94). In case of full occupancy, the procedures go to the “Full occupancy Er-2” menu, and in case there are vacancies new participants the procedures go to the “Call for new participant” mode. On the “Full occupancy Er-2” menu, the message about full occupancy is announced and an inquiry is made whether a participant will hang up or return to the conference later. In case that the phone of a present participant is hung up, the procedures go to “Full occupancy R-5” menu in FIG. 6B, and in case that a participant is to return to the conference, a message to that effect is announced.

In case the phone of present participant is hung up, the procedures go to the “hang up” step (step 96), and the procedures then go to “Call for new participants: 2” mode.

In case the participant wants to listen to the message from the non-participant or non-attendant, the number of the non-participant is announced (step 100) and then the message from the non-participant is reproduced (step 102). If the participant wants to listen to the message again, the procedures go back to step 102 (step 104). If the participant requests that the message be deleted (104), the message is then deleted (step 106).

In case a group registration is requested, the procedures go to “Group registration: 4” mode further shown in FIG. 8.

In case confirmation of the present participants is requested (option 5), the present participants are announced (step 107).

If a return to the conference is requested, the message to that effect is announced and the participant returns to the conference (step 108).

In FIG. 7a, the basic menu for the “Call for new participant: 1” mode is shown. The number of the new participant is input (step 110). With the input the extension number of the new participant can be designated. In case the capacity for the conference room goes over the full number, the procedures go to “Full occupation Er-2” menu. On the “Full occupation Er-2” the message of full occupation is announced, and whether the phone is to be hung up or whether the participant will return to the conference is inquired. In case that the phone of the present participant is hung up, the procedures go to “Full occupation R-5” menu in FIG. 6B, and in case that the participant returns to the conference, the message to that effect is announced and the participant returns to the conference. When the input of the phone number is proper in step 110, a new participant is called (step 112) and the procedures go to the “After Call D-1” mode, which is linked to the basic menu start in step 86 in FIG. 6A.

In FIG. 7B, the basic menu for “Disconnect participant: 2” mode is shown. The phone number desired to be hung up is input. The extension number can also be designated The phone which is desired to be hung up is hung up (step 116), and then procedures go to the “After Disconnection D-1” mode in FIG. 6A which is then linked to the basic menu start in step 86.

In FIG. 8, the basic menu for “Group registration” is shown. When group registration of the present participants at the step 92 in FIG. 6A is selected, the group number is requested for input (step 118) and thereafter the number thus input is confirmed (step 122). When the participant wants to do it again, the procedures go back to the step 118. When the input number is correct, the group number is announced (step 124). Thereafter, the procedures go to the “After Registration D-1” mode in FIG. 6A which in turn goes to the step 86. When the group is registered, if the group number is input the next time, the participants which belong to the group can be retrieved.

In FIG. 9, the procedures for the error message “Members are over the full number for participants” is shown. It is a routine from the “Full occupancy Er-1” in FIG. 3. A message to the effect that the seats have been already full occupied is announced (step 126) and it is inquired whether to call the input participants or to input the number of participants again (step 128). When the number of participants is to be input again, the procedures go to the “A-2” mode in FIG. 3. In case input participants are to be called, the procedures go to the “A-3” mode in FIG. 3.

In FIG. 10A, the procedures for the error message “When the phone of the host is disconnected” is shown. When the phone of the host is hung up, a message to that effect is announced (step 136) and the phones of all participants are caused to hang up.

In FIG. 10B, the procedures for the error message “Reentry when the phone of the host is disconnected” are shown. This menu may alternatively be used in place of step 136 in FIG. 10A. When the phone of the host is hung up, an inquiry is made whether the conference is to be terminated (step 138). If the conference is to be terminated, the phones of all participants are caused to be hang up after one minute. In case the conference is not to be terminated and the reentry of the host is awaited (step 140), the conference is restarted when the host reenters the conference room again within one minute. Furthermore, before the reentry of the host, the conference can be carried on between the participants. If the host does not enter the room again within one minute, the phones of all participants are caused to hang up.

During a conference the volume of a phone call is adjustable. A particular person of the participants can be enabled to speak by the host. Moreover, since there is a plurality of conference rooms, a plurality of groups can have phone conferences at the same time.

The present invention can be embodied using the above-mentioned flowcharts and therefore telephone conferences can be held at the same time between remote places where there are no video conferencing phones.

According to the above-described embodiment, connection of participants for a telephone conference can be made without an operator, and the conference system can be utilized at any time (24 hours). The system allows a new participant to be called during the conference. Further, when a user utilizes the phone conference system, initial registration is not required although a password at the start stage of the conference system is required.

Now, a modified version of the first embodiment of the invention will be explained. In the above described example, push buttons of the phone are operated in response to user instruction messages generated from the voice response board 6, in order to carry out the conference call as has been explained. In the modified version, operation of a conference call by cell phones through wireless digital data connections will be explained. In FIGS. 11-13, the functions enabled by the user interface on the input picture plane of a cell phone are shown for transmitting selections and information to the voice response board 6 from the cell phone through wireless connections.

FIG. 11 shows the user interface on an input picture plane for the “Host: start” menu. At first the user's ID (identification) and password are requested to be input. User options include (1) Conference, (2) Registration of message, (3) Registration of group, and (4) Address book.

In case the user selects the Conference option, the Conference menu (1) is displayed on the picture plane. The user can select (1) “Input phone nos. and

designate participants” and (2) “Call for group”. FIG. 12 shows the user interface in case of selection of option (1), allowing phone numbers (or abbreviated member numbers) of the participants to be input. When the designated participants are input, the “Call” button can be pushed. In case of selection of option (2), a group number is input, and a list of the group members is displayed. When the desired members are checked, the “OK” button can be pushed, and the “Call” button is pushed to start the call. When it is desired to remove members from the group, checks are not put in the check boxes, the “OK” button is pushed, then the “Call” button is pushed.

In FIG. 13, the interface after selection of “(2) Registration of message” in FIG. 11 is shown. The options (1) to record a new message and (2) to alter an input message are offered. In case of selection of option (1), the record button is pushed to record a message and the # key is pushed to end. In case of selection of option 2, the number of input message is input and a new message may be recorded in place thereof.

Similar procedures are followed for selection of options “(3) Registration of group” and “(4) Address book” in FIG. 11, in a similar manner as has been explained for options “(1) Conference” and “(2) Registration of message”.

The voice response board 6 can receive selections and information input on the cell phone, and the control section 18 can receive line information from the voice response board 6 in response to the selections and information thus received and transmits exchange connection to the voice response board 6.

As mentioned above, since the input information can be transmitted while confirming the input information on the picture plane of the user interface on the cell phone, errors in operations are not likely to be caused and operations and transmission of information are made reliable and convenient.

### Second Embodiment

In the second embodiment of the invention, the functional configuration of the telephone conference system shown in FIG. 1 is also used. Explanation on any parts or functions of the second embodiment which are same or similar to those of the first embodiments will be omitted.

In the second embodiment, the simplified user instruction module 14 has functions to store the phone numbers of the participants' telephone lines and to check the caller ID number of a phone line of a caller to the stored phone numbers to determine if a re-connecting party is an intended party to a telephone conference. The simplified user instruction module can simultaneously connect a plurality of phone lines to one transmitting line. However, since the simplified user instruction module 14 is connected to the calling line and also connected to the plurality of phone lines, the simplified user instruction module itself does not directly connect the calling line to the plurality of phone lines and is not a section where voice signals are exchanged between lines. The exchanges are instead carried out in the rooms 16 of the voice response board 8.

Now, the operation of the above-mentioned construction will be explained. Referring again to FIG. 1, a phone line is connected to the server 4 through the public network by transmitting push tone signals. In the server the simplified user instruction module 14 of the voice response board 6 receives the call signal from the push tone signals. Thereafter, the signal for inquiring for status of each room 16 reaches the control section 18, and the control section 18 transmits the signals for indicating to the simplified user instruction module 14 in response to the status of each room. If vacant, the room is reserved for a conference.

As before, the simplified user instruction module 14 requests the phone numbers of the members who the host wants to designate. The simplified user instruction module 14 stores the phone number of the host and the phone numbers of members whom the host designates. When the members receive a call from the host announcing a conference at a predetermined time, then the members and the host hang up.

After the conference has been announced to the members, the members call for the host at the predetermined time, for example in 5 minutes. The members can call through a public network to connect to the telephone conference server 4. In the server 14, the simplified user instruction module 14 of the voice response board 6 receives the call signals. The simplified user instruction module 14 recognizes the phone numbers of the members and checks whether the phone numbers coincide with the stored phone numbers of the members which the host designated. If the phone numbers coincide, the simplified user instruction module 14 connects the lines from the members. If not, the line is not connected.

The confirmed phone numbers of the members are delivered from the simplified user instruction module 14 to the control section 18, and the control 18 issues the order for connection of lines by exchange in the room designated by the host. The simplified user instruction module 14 transmits line signals to the room 16 thus connected. The lines of the members are thus connected to the line of the host. Since the room is a conference room, the room synthesizes the voice signals for messages to the plurality of lines to be connected by exchange. The synthesized voice signals are issued to the simplified user instruction module 14 which in turn issues the message to each phone.

On the basis of above-mentioned hardware configuration, the processing operations will now be explained in more detail. FIGS. 14-16 are flowcharts showing the detailed processing operations of server 4 of the phone conference system according to the second embodiment of the present invention. In the flowcharts, a rectangular frame indicates a message given in voice.

In FIGS. 14A and 14B, a start menu of the host is shown. The host makes a phone call to the server 4. When the server 4 receives push tones from the host, whether a conference room 16 is vacant or not is checked (step 30′). In case the room is used, an in-use reply message is given (step 32′) and then disconnection is made by the host. In case the room is vacant, whether there is sender information is checked (step 34′). If there is no sender information, a message to the effect that the phone is to be redialed with a recognized phone number is given (step 36′) and the line is disconnected. In case there is sender information, an opening message is delivered (step 38′) and whether the host desires to record an opening message is inquired (step 40′). The message is the one that the host delivers to the participants. In case of recording, the procedures go to “Record A-1” mode. In case of non-recording, the procedures go to prompting the host to input the phone number of participants (step 42′).

When the phone numbers of the participants are input (step 44′), if the fixed number provided for the conference room 16 is exceeded, the procedures go to the “Full occupancy Er-1” menu (detailed explanation will be omitted). In case of proper input, the participants are called (step 50′).

When the participant is called, the conference time is announced, and the phone is hung up and the host waits for the phone call from the participants (step 52′). The participants who are called go to the “Participant” mode.

The call back responses of the some or all of the members is checked (step 54′). In case of no response from all members (step 58′), the host is returned to beginning the procedures again in the “A-2” mode. The host can opt to call a non-responding member again, and the procedure goes to the “A-3” mode. In case of no response from some members in step 54′, the message to the effect that the host is waiting for calls from the participants is announced (step 56′) and then the host hangs up.

In FIG. 15A the host “Record menu” is shown. The steps are same as those of FIG. 4A and therefore the explanation thereof will be omitted.

In FIG. 15B a participant “Start menu” is shown. When the participant gets a phone call from the host, an opening message is announced to inform the participants of the conference and that they should hang up once and redial within a certain time, say 5 minutes. In case that there is a message from the host, the message is played back (step 60′).

In FIG. 16 a participant transmission menu is shown. When the server 4 receives call signals from the participants, the server judges whether the call from the participant occurred within a predetermined time (5 minutes in the embodiment) from the calling of the host (step 74′). In case of overtime, the message to that effect is announced and the phone is caused to hang up (step 76′). In case the call is in time, the server checks whether the caller ID number of the participant is the same as that input by the host (step 78′). If different, the message to that effect is delivered (step 80′) and the phone is caused to hang up. If it is the same, the participant is permitted to enter the conference room (step 84′).

In FIG. 17A, a basic menu for group registration is shown. When the basic menu is called during the conference, the basic menu start message is announced (step 100′). The number of conference participants is announced (step 102′) and in case that there are non-attendance messages, the number of non-attendance messages is announced (step 104′). The options are then given whether a new participant is to be called, whether the phones of present participants are to be hung up, whether the participant want to listen to the non-attendant messages, whether the group registration is to be made, whether the present participants are confirmed, and whether the participant want to return to the conference (step 106′). In case that there is a non-attendance message at step 88, the procedures go to step 106′.

In case that a new participant is called for, the number of the new participant is input (step 108′). In case of full occupancy, the procedures go to the “Full occupancy Er-2” menu, and in case that there are vacancies for seats the procedures go to the “Call for new participant” mode.

In case that the phone of present participant is to be hung up, the procedures go to the “Disconnection” step (step 110′) and to the procedures for the “Call for new participants: 2” mode.

In case that the participant listens to the message from the non-attendant, the number of the non-participant is announced (step 114′) and then the message from the non-participant is reproduced (step 116′). In case that the participant wants to listen to the message again after reproduction, the procedures go back to step 116′ (step 118′) and in case that reproduced message is to be deleted (118′), the message is deleted (step 120′).

In case of selection of group registration, the procedures go to “Group registration: 4” mode.

In case of selection of confirmation of present participants, the present participants are announced (step 121′).

In case of selection of return to the conference, the message to that effect is announced and the participant returns to the conference (step 122′).

Now, a modified version will be explained. In the above-mentioned example, the buttons of the phone are operated in accordance with voice messages generated from the voice response board 6, and then the conference call is carried out. In the modified version, the operation of the conference call carried out by cell phones with wireless service will be explained. In FIG. 18, there is shown an input picture plane for transmitting selections and information to the voice response board 6 from the cell phone. The procedures explained with reference to FIGS. 6 and 8 in the first embodiment are applicable to the procedures in the second embodiment.

In FIG. 18, the procedures when option “(1) Input phone numbers” or option “(2) Call” is selected have been already explained with reference to FIG. 12. In FIG. 18, in case of selection of option “(3) Call following participant”, the name of the participant is displayed. When the participant is called, the call button is pushed.

It is understood that many modifications and variations may be devised given the above description of the principles of the invention. It is intended that all such modifications and variations be considered as within the spirit and scope of this invention, as defined in the following claims.

1. A telephone conference system for connecting a plurality of phone lines of participants in a telephone conference comprising:
a voice response board for receiving and transmitting push tone signals and voice signals from and to each phone line of a participant, and for recording and reproducing the voice signals for a telephone conference in response to participant input indicated by the push tone signals;
a voice synthesis board coupled to the voice response section capable of establishing a plurality of telephone conference “rooms” in which voice signals from each participant's phone received for a specific conference room by said voice response board are synthesized as voice sounds for the other participants in the conference room; and
a control section for checking the available status of a conference room of said voice synthesis board, and for receiving line information of each phone line from and transmitting requests for connection with other phone lines to said voice response section in response to an indicated available status of the conference room of said voice synthesis board,
wherein said control section designates a conference room to be connected to each phone line of the participants in a telephone conference connected to said voice response board, the voice signals of the plurality of phone lines of participants are synthesized and are connected by exchange in said designated conference room, and a plurality of persons are thereby enabled to participate in a telephone conference simultaneously through their respective phones.

2. A telephone conference system according to claim 1 in which during connection of the plurality of phone lines of participants to a telephone conference, said voice response board enables a newly designated participant to be called and to be invited to join the telephone conference.

3. A telephone conference system according to claim 1 in which during connection of the plurality of phone lines of participants to a telephone conference, said control section sends an order to said voice response board to disconnect a phone line of a party calling to connect to a telephone conference if it is not recognized.

4. A telephone conference system according to claim 1 in which during connection of the plurality of phone lines of participants to a telephone conference, when the line of a host is disconnected, said control section sends an order to said voice response board to disconnect the phones lines of all participants of the telephone conference.

5. A telephone conference system according to claim 1 in which said voice response board is enabled to record a voice message of a host to be sent to the intended participants of the telephone conference.

6. A telephone conference system according to claim 1 in which said voice response board is enabled to record a voice message of an intended participant to a telephone conference, and thereafter during connection of a host for a telephone conference, said voice response board reproduces the recorded message of the intended participant.

7. A telephone conference system according to claim 1 in which said voice response board is enabled to record a voice message of a participant re-connecting to a telephone conference, and thereafter during connection of a host for a telephone conference, said voice response board reproduces the recorded message of the participant.

8. A telephone conference system according to claim 1 in which a host is enabled to input phone numbers for intended participants to be called and invited to join a telephone conference.

9. A telephone conference system according to claim 1 in which a time is set for participants to re-connect for a telephone conference within a predetermined time after the participants are called and invited to join the telephone conference.

10. A telephone conference system according to claim 1 in which a record section is provided for recording information to be provided to each intended participant in a telephone conference.

11. A telephone conference system according to claim 10 in which the information recorded in the record section is displayed on a display panel for the system in real time.

12. A telephone conference system according to claim 1 in which during connection of the plurality of phone lines of participants to a telephone conference, in case that the phone line of a host is disconnected, a predetermined time is provided for the host to be re-connected to reenter the conference room, and in case the host is not re-connected within the predetermined time, the phone lines of all participants are disconnected.

13. A telephone conference system according to claim 1 in which said voice response board is enabled to transmit and receive information to and from a cell phone through a network connection.

14. A telephone conference system according to claim 1 in which a host can store on said system a prior list of participants for telephone conferencing, and subsequently check from said list certain participants to be invited to join a current scheduled telephone conference.

15. A telephone conference system for connecting a plurality of phone lines of participants in a telephone conference using a computer system comprising:
a voice response board for receiving and transmitting push tone signals and voice signals from and to each phone line of a participant, for recording and reproducing the voice signals for a telephone conference in response to participant input indicated by the push tone signals, and for recording the phone numbers of intended participants and recognizing caller ID (identification) numbers of calling parties re-connecting for a telephone conference for comparison to the recorded phone numbers of intended participants to the telephone conference stored by said voice response board;
a voice synthesis board coupled to the voice response section and provided with a plurality of conference rooms, wherein voice signals from each participant's phone received for a specific conference room by said voice response board are synthesized as voice sounds for the other participants in the conference room, and for connecting by exchange the phone lines re-connecting with said voice response board in accordance with recognizing the caller ID numbers of the phone lines matching the phone numbers stored by said voice response board; and
a control section for checking the available status of a conference room of said voice synthesis board, and for receiving line information of each phone line from and transmitting requests for connection with other phone lines to said voice response board in response to an indicated available status of the conference room of said voice synthesis board,
whereby the telephone conference system through said voice response board is enabled to recognize the caller ID numbers of phone lines to be connected to a conference room and compare them to the recorded phone numbers of the intended participants to the telephone conference to determine if they are true participants to the telephone conference.

16. A telephone conference system according to claim 15 in which during connection of the plurality of phone lines of participants to a telephone conference, said control section sends an order to said voice response board to disconnect a phone line of a party calling to connect to a telephone conference if the caller ID number is not recognized.

17. A telephone conference system according to claim 15 in which a time is set for participants to re-connect for a telephone conference within a predetermined time after the participants are called and invited to join the telephone conference.

18. A telephone conference system according to claim 15 in which a host can store on said system a prior list of participants for telephone conferencing, and subsequently check from said list certain participants to be invited to join a current scheduled telephone conference.

19. A telephone conference system according to claim 15 in which said voice response board is enabled to transmit and receive information to and from a cell phone through a network connection.

20. A telephone conference system according to claim 19 in which said voice response board is enabled to transmit information to the cell phone to display various options for participating in a telephone conference.
